(19) United States
(12) Patent Application Publication
(10) Pub. No.: US 2026/0218084 A1
(43) Pub. Date: Jul. 30, 2026

(54) CLEANING COMPOSITIONS, CHEMICAL-MECHANICAL PROCESSES AND UNIFIED HYDRODYNAMIC SYSTEM FOR CLEANING CLOTHING IN CELLULOSE, PAPER, TEXTILE, AND SIMILAR MACHINES

(71) Applicants: Ricardo REIS DE CARVALHO, Valinhos (BR); Ana Carolina DA COSTA CARVALHO, Valinhos (BR)

(72) Inventors: Ricardo REIS DE CARVALHO, Valinhos (BR); Ana Carolina DA COSTA CARVALHO, Valinhos (BR); Luiz Antonio FONSECA DE GODOY JUNIOR, Valinhos (BR); Jéssica KUNSMINSKAS DA SILVA, Valinhos (BR)

(73) Assignees: Ricardo REIS DE CARVALHO, Valinhos (BR); Ana Carolina DA COSTA CARVALHO, Valinhos (BR)

(21) Appl. No.: 19/343,984

(22) Filed: Sep. 29, 2025

(30) Foreign Application Priority Data
Jan. 27, 2025 (BR) 1020250015315

(51) Int. Cl. C11D 1/83; C11D 3/04; C11D 3/39

(52) U.S. Cl. CPC C11D 1/83; C11D 3/04; C11D 3/3942; C11D 2111/12; C11D 2111/44

(57) ABSTRACT

The present invention relates to the use of nanobubble solutions or cleaning compositions containing nanobubble solutions associated to oxidant types and/or surfactant solutions, a chemical-mechanical process and a unified application system for cleaning paper and cellulose machines clothing, textile, tiles and tannery, without using steam and high pressure, with the purpose of removing the recurrent hydrophobic organic contaminants in the processes of the paper and cellulose industry, known with pitch, stickies and the like, originating from virgin cellulose and offcuts, as well as other types of organic and inorganic contaminants.

### FIELD OF THE INVENTION

The present invention comprises cleaning compositions, a chemical-mechanical process and a unified application system for cleaning paper and cellulose, textile, tiles and tannery machines clothing, without using steam and high pressure, with the purpose of removing hydrophobic organic contaminants recurrent in the processes of the paper and cellulose industry, known as pitch, stickies and the like, originating from virgin cellulose and offcuts, besides other types of organic and also inorganic contaminants, found in processes of the paper and cellulose, textile, tiles and tannery industry.

The compositions available are combinations of nanobubbles with surfactant solutions and/or oxidant species, integrating application methods in the process of cleaning clothing, based on a single homogenization system, without the need for individualized injectors, steam insertion and high pressure.

### BACKGROUND OF THE ART

The hydrophobic organic contaminants noted in the manufacturing processes of the cellulose and paper industry, known as pitch, stickies and the like, originate from virgin cellulose and offcuts, respectively, being the main causal factors of the problems found in the end paper production, such as page breaks, holes in the paper, production losses in manufacturing and conversion, use of solvents and operating rework.

The treatment of the paper and cellulose machines clothing is today a reality of vital importance for competitive product cost and to keep high levels of productivity and quality of the paper produced, especially in light of the current levels of water circuit closing, whose contents of organic and inorganic contaminants are increasing, causing a greater occurrence of deposits, which compromise the drainability of water and, consequently, the useful life of the felts and screens.

The production of cellulose and paper is a long and challenging process. One of these challenges is precisely attributed by the complexity of the raw materials for producing cellulose pulp: wood. Wood is made up of various classes of compounds, such as cellulose itself, hemicelluloses, lignin, inorganic components (minerals) and organic extractives. These organic extractives are compounds belonging to different chemical classes, such as fatty acids, lipids, terpenoids and phenyl compounds [Cruz et al. Quim. Nova, Vol. 29, No. 3, 459-466, 2006]. Many of these compounds present in the extractives are not soluble in water and tend to form deposits in the very cellulose pulp or in components from machines and equipment of the process. These deposits are called pitch.

Many papers and wrappers are produced from recycled and reprocessed paper, commonly called offcuts on the paper market. By consequence, chemical components used as additives for production of paper and in the finishing phase of the end product are carried with the reutilized fibers by the processing of offcuts. Among these additives, there are organic components insoluble in water and hard to remove, called stickies. These components can also form deposits along the productive process [ALMEIDA M., LOCAHEN R.; Resumos Congresso Anual de Cellulose and Papel, São Paulo, Brasil, 1991].

The deposition of pitch and stickies is one of the largest difficulties faced by producers of cellulose and paper, because deposition in the pulp, which occurs by a strong interaction between these components and the cellulose fiber, may compromise the quality of the product, causing the formation of holes, tears, among other flaws in the cellulose sheet/paper [Randrup, R.; Resumos do XVII Congresso Anual da Associação Brasileira de Cellulose and Papel, São Paulo, Brasil, 1984].

Additionally, the deposits of pitch and stickies cause effects on the functionality of machines and systems of the productive process, which provokes undesirable stoppages of machines that interferes in the productivity, as well as expenses with maintenance and high consumption of chemicals for corrective actions, generating major economic and environmental impact.

The treatment of clothing (felts and screens) in cellulose and paper machines make use of robust technologies specifically designed for cleaning these systems. These clothing are important components in machines that form and dry cellulose and paper, since they help in forming homogeneous sheets and guarantee a drainability of water suitable for obtaining the product within the standards of dry content and physical-mechanical properties. The clothing of this productive process are formed by different polymers, commonly polyamides and polyesters (and polyurethanes in some cases), and are called felts and screens.

Despite having the same name, the denomination of clothing used in the paper and cellulose industry and in the present invention is not corelated with the usual denomination of clothing in the context of textile or clothing industry, usually focused on the production of textile articles, such as clothes, hats, coats and accessories, as well as in the production of curtains, rugs and carpets. The words clothing(s), felt(s) and screen(s) for this invention can be summarized as a technical material or else a functional equipment, used chiefly for drying and in the transport of the cellulose sheets and paper along the process of its manufacture. However, this equipment can be used in other industries that require a mechanical support, like the tiles and tannery industries. Even the textile industry can make use of said industrial clothing in its manufacturing process to produce its fabrics.

Cleaning these felts and screens to control the pitch and stickies is crucial to avoid the formation of obstructions, guarantee of regularity in production and greater durability of the clothing in the productive process.

Therefore, the use of technologies to reduce or eliminate the deposits of pitch and stickies on screens and felts is of the utmost importance for this market. Developing new solutions or improvements on existing solutions for treating clothing assure the sustainability of this industrial sector.

Usually, the solutions from the state of the combine water, steam and chemical products to produce an activated solution by using pressure and high temperature, as can be seen in patent PI 0503029-3.

Subsequently, the clothing cleaning systems present in the state of the art, focused on the paper and cellulose manufacturing process, are made up of a set of chemical products or cleaning compositions, added to chemical-mechanical processes involving the application, via direct injection, of these products, generally involving an alkaline surfactant solution added to the separate application of an activated solution that includes water, nanobubbles and acid or neutral surfactant solution and oxidants, combined through a hydrodynamic mixer.

In this sense, we have seen the solution of performing the same procedure without raising the temperature or even using high pressure. As the most representative example of the state of the art for this purpose, there is document BR102023015577-4, which also refers to a chemical-mechanical process and continuous hydrodynamic system to control contaminants in industrial machines, which comprises a mixture chamber, combining water, chemical products and nanobubbles to produce an activated cleaning solution without using steam, with high cleaning power. In this document BR102023015577-4, the equipment used carries out the application by means of two sprinkler showers, one for applying an alkaline surfactant solution and another for applying a homogenized mixture of acid or neutral surfactant solution, oxidizing solution and nanobubbles.

Although this concerns an advantageous technology over the other processes, equipment and systems from the state of the art that make use of pressure and high temperature, the solution given by BR10 2023 015577-4 falls short by the excess of devices, infra-structure, procedural steps and by having a greater consumption of water, since it applies in separate showers two different solutions for cleaning the clothing.

It is noted that leaner and more economical systems could be developed in more in-depth applied studies, without losing the efficiency in cleaning and with lower water consumption. The solution presented using two injectors and another mixer performs an effective process, but requires operational structures and installations that could be reduced and, with this, also reduce expenses with maintenance and space necessary to carry out the process. This would lead to general cost savings, as well as time, water and reagents, so altogether an environmentally friendlier solution.

In view of the analysis of the Brazilian patent document cited above, the question arises as to whether there exists the possibility of creating a chemical-mechanical system that also replaces the pressure and the increase in temperature by the use of cavitation processes, which would combine the alkaline surfactant solution to the other components to produce the activated solution in just one mixer and just one injection system, but that is still capable of performing the cleaning with high efficiency, unifying and optimizing the system of application, disregarding the need for two systems injectors.

Accordingly, it would be interesting to develop and test a new equipment with leaner structure in a smaller installation space, to appraise, in light of that described in document BR 10 2023 015577-4, whether it would be possible to obtain a simplified and unified system, but still effective, of applying the solutions in the treatment of clothing, generating greater viability and savings on production in the paper and cellulose industries and similar sectors.

### BRIEF DESCRIPTION OF THE INVENTION

The present invention, therefore, derives from a combination of comparative studies in an industrial environment that enabled the developing of a single system of mixing and applying cleaning compositions, by equipment and chemical-mechanical processes for treating paper and cellulose machines clothing and the like.

The system was developed in optimized fashion from comparative studies between different combinations of surfactant agents, oxidants and nanobubbles, enabling a unification of the application of activated cleaning solutions in the process of cleaning the contaminants noted in the paper and cellulose industry manufacturing processes, known as pitch, stickies and the like, to obtain the best system of treating the clothing.

The group of inventors recognized the synergistic potential for mixing and applying the components involved in the activated cleaning solution in a unified fashion, so as to optimize the present methods present in the state of the art, constituting the essence of the present invention.

Therefore, the starting block of the present invention is a hydrodynamic system known in the state of the art, as described in document BR 10 2023 015577 4, incorporated herein as main reference, an integral part of the present document and source of comparison, as it conjugates a mixing chamber, which combines water and nanobubbles (solution of nanobubbles) or a solution of nanobubbles and chemical products to produce an activated cleaning solution without using steam, with a high cleaning power, through the application that makes use of two injectors, one being for the application of alkaline surfactant solution and the other for application of homogenized mixture of acid or neutral surfactant solution, oxidant solution and nanobubbles.

However, in the studies carried out, it was unexpectedly noted that there was no need to separate the inclusion of the components. Evidence from the state of the art indicated that said components could not be placed at the same time due to the risk of chemical reactions between them or else to avoid the partial cancellation of its functions (such as, for example mixtures of hydrogen peroxide-based oxidant solutions with alkaline solution or else acid solutions with alkaline) being diluted in other chemical products and in water. And, therefore, this was not even cogitated in document BR 10 2023 015577 4, attaining an efficient system, yet still having room for improvement.

This being the case, the present clothing treatment system comprises a single injector system (in processes having just one solution to be injected-solution of nanobubbles) or a single mixing chamber, when there is more than one solution, which can be understood as any industrial recipient that is capable of mixing the fluids, also without using steam and high pressure, but that integrates the mixture of all the components at a single moment, unifying the form of application through a single injector, optimizing the homogenization between the nanobubbles generated previously, combined with the oxidant formulations and surfactant formulations (alkaline, neutral and/or acid).

In this sense, by unifying the system of applying solutions to treat clothing, it is possible to create greater feasibility, reducing structural and operational needs for installations and maintenance of the system. Additionally, unifying the system of application promotes a significant reduction in the consumption of water used for dilution and feeding the cleaning solutions to the cleaning system. In light of the challenges currently faced by the lack of water, the guarantee of saving in the use of water represents an extremely positive impact for developing the system now proposed.

Consequently, in a first embodiment of the invention, the cleaning compositions may be part of more complex but more efficient combinations than those set out in document BR 10 2023 015577 4, and may comprise combinations between (units in weight by volume-% W/V): 0 to 20% of oxidant formulations and 0 to 20% of surfactant formulations, comprising from 0.001 to 40.000% of this first combination, and the addition of 60.000 to 99.999% of solution with nanobubbles, previously mixed in the mixing chamber and inserted jointly in the process for cleaning the felts and screens of the paper and cellulose industry, which will act jointly to clean the pitch and stickies, starch, carbonates, talcum, glues, resins, among other organic and inorganic compounds, originating from virgin cellulose, offcuts and residues of chemical products employed in the process, which become stuck during the production process in paper machines of different segments such as cellulose, wrapping paper, tissue, print/write, card paper, newsprint paper, whose contamination profile of the extractives is significantly different, just as in applications of other sectors like in tannery, textile and tiles.

The compounds that can be mixed to form the active part of the cleaning composition of the present invention will be called surfactant solutions (LR), oxidant species (OR) and solution with nanobubbles (RG), according to the following description:

TABLE 1
Abbreviations of the reagents involved in the present invention.

| Abbreviation | Components |
|---|---|
| LR1 | Acid Surfactant Solutions |
| LR2 | Neutral Surfactant Solutions |
| LR3 | Alkaline Surfactant Solutions |
| OR | Oxidant Types |
| RG | Solution with Nanobubbles |

The second embodiment of the invention contemplates the cleaning process of the clothing involving a first step of mixing, performed in a hydrodynamic chamber that mixes the surfactant solutions and/or oxidants with nanobubbles (LR, OR and RG) in a static-type mixer (101). And, in a second sprinkling step (102) by injector spouts (102A) of the mixture of one of the compositions selected, on the felt or screen (103), preferably in the direction of the roll.

In one preferred embodiment of the process, the mixture made in the mixer (101) will contain at least one of the LRs (LR1, LR2 or LR3) added to the RG, the mixture by sprinkling (102) applied by injector spouts (102A), as described in FIG. 1.

Lastly, the third and last embodiment of the invention refers to the unified hydrodynamic cleaning system (100), containing equipment such as fluid mixing chamber (101), showers (102), injector spouts (102A), for cleaning the clothing rolls (103), typical of the paper and cellulose industry, associated in this invention to equipment forming nanobubbles and compositions and chemical products as described in Table 1. The choice of the best composition will depend on the specific contaminants present in the clothing of each segment.

### BRIEF DESCRIPTION OF THE DRAWING

The drawing referred to below represents a particular embodiment of the invention, and reference thereto does not impose any limitation other than those contained in the claims.

FIG. 1—illustrates a schematic view of the system (100) for treating the paper and cellulose machines clothing and akin areas (103) without using steam, wherein: 101—mixing chamber of fluids; 102—shower (or sprinkler); 102A—ejector spouts (or injectors); 103—felt or screen; LR1 acid surfactant solution; LR2—neutral surfactant solution; LR3—alkaline surfactant solution; OR—oxidant species; and RG—solution with nanobubbles.

### DETAILED DESCRIPTION OF THE INVENTION

The invention is described below with a view to facilitating the comprehension thereof, and said description does not impose any limitation thereon other than those expressed in the accompanying claims.

The present invention therefore refers to different combinations and cleaning compositions, a chemical-mechanical cleaning processes in a unified mixture and application system capable of treating the paper and cellulose machines clothing and the like by the isolated or combined use of nanobubbles, surfactant solutions and/or oxidant species, without using steam, as shown by the benefits listed below:
Optimization of a clothing conditioning system with cleaning efficiency similar or superior to the technology described in document BR 10 2023 015577 4, incorporated herein as a comparative example to demonstrate the unexpected effect relative to the state of the art, by mixing and applying the components selected in a unified fashion;
Use of a single shower (102) with injector spouts (102A) for applying the activated solution, unifying the form of application of the cleaning composition;
New hydrodynamic equipment which can be a static-type mixing chamber (101), capable of replacing thermo-dynamic equipment;
Unified mixture of the components (cleaning composition), boosting the improvement of homogenization and activation of the solution composed by 100% of solution with nanobubbles and preferably adding oxidant species and/or surfactant solutions;

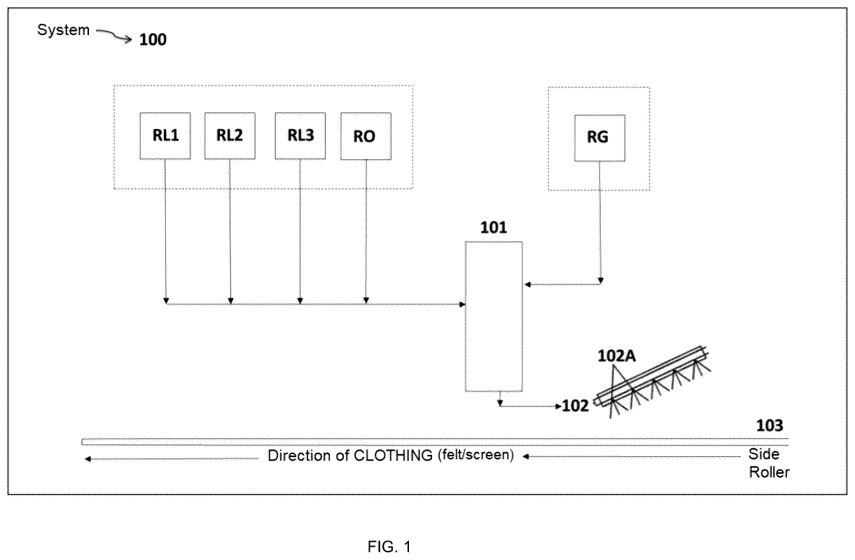

Bearing in mind that the essence of the invention is the system (100) capable of treating the paper and cellulose machines clothing by the isolated or combined use of nanobubbles with oxidant species and surfactant solutions, below is a description of the component equipment and chemical products in the schematical view illustrated in FIG. 1.

In general, the preferred chemical products of the system (100) with surfactant action may comprise Liquid Reagents (LR), Oxidant Reagents (OR) and a solution of nanobubbles (RG), of which (LR1) is an acid formulation, (LR2) a neutral formulation and (LR3) an alkaline formulation, in addition to (RG) which comprises a solution of nanobubbles. In turn, the oxidant species (OR) can be formulations of hydrogen peroxide or persulfates such as, for example, ammonium persulfate, or oxidant gases such as ozone.

The equipment of which the system (100) is comprised is similar to the constituents of the hydrodynamic system known in the state of the art, according to document BR 10 2023 015577 4, and stands out for the unification of the application of the alkaline formulation (LR3) with the mixture of the other components (LR1, LR2, OR and RG), disregarding the use of an individualized injector shower (relative to BR 10 2023 015577 4), optimizing the structure of the equipment, according to the illustration of FIG. 1. Accordingly, the mixing chamber (101) of fluids proposed here can be a static-type mixer. However, a person skilled in the art could replace the mixing system for any recipient, tank and the like, provided it permits the simplification of the structure utilized.

### EXAMPLES

The data and exemplary methods of the present invention is similar to those described in document BR 10 2023 015577 4. Experiments were carried out on the application and the efficiency in cleaning the samples of contaminated substrates (felt coupons) with different combinations of the cleaning composition.

### Example 1—Tests of Validity of the Optimized Technology for Various Segments

The efficiency was evaluated in the performance of cleaning samples of coupons from different segments, through the combination of the different components that make up the unified application system of the activated solution proposed in the present invention-LR1, LR2, LR3, OR and RG-comparing the cleaning action of the double application reference method (use of the individualized alkaline solution, followed by the application of the activated mixture).

The continuous test condition was used, as described in document BR 10 2023 015577 4, for application in the tests with different combinations. Coupons were selected from the segments of cellulose, wrapping paper, tissue and print/write and tiles whose contamination profile of the extractives is significantly different. The tests were carried out, varying the quantities of surfactant solution (LR) and oxidant solution (OR) used, complementing the composition with the solution of nanobubbles (RG). The saturated solution of nanobubbles (RG) was generated by the commercial equipment Holly Nano Bubble Generator (model HLYZ-01).

The main results of the study are present in the following table:

TABLE 2
Efficiency of Conditioning in Felts for sundry segments

| | | | | | | Cleaning |
|---|---|---|---|---|---|---|
| | Concentration | Concentration | Concentration | Application | | efficiency |
| Components | of LR3 | of OR | of RG | System | Segment | (%) |
| LR3 + OR + RG | 2% | 1% | 97% | Double | Cellulose | 65 |
| LR3 + RG | 2% | 0% | 98% | Unified | Cellulose | 68 |
| LR3 + OR + RG | 0.5% | 1% | 98.5% | Double | Packaging | 85 |
| LR3 + RG | 0.5% | 0% | 99.5% | Unified | Packaging | 83 |
| LR3 + OR + RG | 0.05% | 0.5% | 99.45% | Double | Print and write | 78 |
| LR3 + RG | 0.05% | 0% | 99.95% | Unified | Print and write | 79 |
| OR + RG | 0% | 0.5% | 99.5% | Unified | Print and write | 77 |
| LR3 + OR + RG | 1% | 0.5% | 98.5% | Double | Tissue | 89 |
| LR3 + RG | 1% | 0% | 99% | Unified | Tissue | 89 |
| LR2 + RG | 1% | 0% | 99% | Unified | Tissue | 85 |
| LR3 + OR + RG | 5% | 0.75% | 94.25% | Double | Tiles | 76 |
| LR3 + RG | 5% | 0% | 95% | Unified | Tiles | 76 |
| LR1 + RG | 2% | 0% | 98% | Double | Card paper | 72 |
| LR1 + RG | 2% | 0% | 98% | Unified | Card paper | 70 |
| LR3 + RG + OR | 1.5% | 1% | 97.5% | Double | Newspaper paper | 68 |
| LR3 + RG | 2% | 0% | 98% | Unified | Newspaper paper | 68 |
| LR1 + RG | 2% | 0% | 98% | Unified | Newspaper paper | 69 |

The results obtained unexpectedly indicate that the application of the components by unified channel (present invention) guarantees a performance similar to the application in a double fashion (BR 10 2023 015577 4), corroborating with the proposal of a simplified and optimized clothing cleaning system.

Lastly, depending on the countless possibilities foreseen for the system now proposed, alterations are expected from the combinations of the composition; and may involve the combination of one or more alkaline, neutral and/or acid surfactant solutions with liquid or gaseous oxidant types and a solution with nanobubbles, making use of equipment, using in different sequences, mixtures with other equipment or chemical products, order in the process and conditions of application, and any parts of the system may be removed or recombined without mischaracterizing the current invention which consists of treating paper and cellulose machines clothing via unified application between the types that make up the system.

Therefore, notwithstanding the particular embodiments detailed herein, the present invention should not be limited to these descriptions. It should, furthermore, be explained to the specialists from the various areas involved that any modifications, apparent or otherwise, can be incorporated as an integral part of the present document and will, nevertheless still be in accordance with the scope of the accompanying claims.

It is known that a person skilled in the art, based on the information and examples contained in this document, may make particular embodiments of the invention not expressly described, but which perform equal or similar functions, to attain the results of the same nature. Said equivalent embodiments will be encompassed by the accompanying claims.

1. AN INDUSTRIAL MACHINE CLOTHING CLEANING COMPOSITION characterized by being applied one time only during the cleaning process of the felts and screens of the clothing and comprises a combination between oxidant species (OR), surfactant solutions (LR), and solution with nanobubbles (RG), comprising a percentage in weight by volume of 0 to 20% of oxidant formulations and 0 to 20% of surfactant formulations, comprising from 0.001 to 40.000% of this first combination, and the addition of 60.000 to 99.999% of solution with nanobubbles, previously mixed and inserted jointly in the cleaning of felts and screens of the clothing of the paper and cellulose industry, which will act jointly in the cleaning of pitch and stickies, starch, carbonates, talcum, glues, resins, among other organic and inorganic compounds, originating from virgin cellulose, offcuts and residue of chemical products employed in the process, which get stuck during the production process in paper machines of different segments like cellulose, wrapping paper, tissue, print/write, card paper, newsprint paper, whose contamination profile of the extractives is significantly different, as well as in applications of other sectors such as in tannery, textile and tiles.

2. The COMPOSITION according to claim 1, characterized in that the preferred composition can be chosen from the combination of:
a) A quantity of 0.01 to 20.00% of LR3—alkaline surfactant formulation; and
b) A quantity of 60.00 to 99.99% of RG—solution containing nanobubbles.

3. AN INDUSTRIAL MACHINE CLOTHING CLEANING PROCESS characterized by using a hydrodynamic chamber that will contain 100% of a solution of nanobubbles or will contain the cleaning compositions as defined in claim 1, comprising oxidant and/or surfactant elements with nanobubbles injected or sprinkled on the clothing by means of a shower 102 with injector spouts 102A during the industrial cleaning process on machines from different segments such as paper and cellulose, wrapping paper, tissue, print/write, as well as from akin and related sectors such as tannery, textile and tiles, besides having the following steps:
a) obtaining the solution of nanobubbles or preparing the reagents according to the cleaning composition, as defined in claim 1;
b) inserting the solution of nanobubbles into the injection or insertion system of the reagent mixture (RG with LR and/or OR) in a mixer;
c) potentiation of the contact between the liquid and gas phases, promoting improved homogenization between the nanobubbles with the oxidant types and/or surfactant solutions; and
d) sprinkling the compositions by means of injector spouts on the felt or screen, preferably in the direction of the roll, and the pressure may vary from 1 to 30 bar, depending on the type of operation and process industrial.

4. The PROCESS according to claim 3, characterized in that preferably the mixture made in the mixer contains RG and LR3 injected by a shower with injector spouts, with preferred pressure from 1 to 4 bar, in the case of paper and cellulose machine, preferably between 1 and 3 bar.

5. A HYDRODYNAMIC UNIFIED INDUSTRIAL MACHINE CLEANING SYSTEM characterized by being used for industrial cleaning of the clothing (felts and screens) from paper and cellulose machines, wrapping paper, tissue, print/write, card paper, newsprint paper, tannery, textile, tiles and akin and similar sectors, comprising:
a) Cleaning compositions as defined in claim 1;
b) Processes as defined in claims 3 and 4;
c) Equipment capable of producing solutions containing nanobubbles;
d) Fluid mixing chamber, capable of potentializing the contact between the liquid and gas phases, promoting homogenization between the nanobubbles generated previously (RG), combined with the reagents LR and/or OR; and
e) Showers with sprinkling-spouts capable of sprinkling reagents on the clothing at pressure of 1 to 30 bar depending on the type of operation and process industrial.

6. The SYSTEM according to claim 5, characterized in that the preferred fluid mixing chamber is a static mixer.
